(19) United States
(12) Patent Application Publication
(10) Pub. No.: US 2022/0382518 A1
(43) Pub. Date: Dec. 1, 2022

(54) EXPONENTIAL CALCULATOR USING PARALLEL PROCESSOR SYSTEMS

(71) Applicant: Bhavesh Lakhotia, Jaipur (IN)

(72) Inventor: Bhavesh Lakhotia, Jaipur (IN)

(21) Appl. No.: 17/584,378

(22) Filed: Jan. 25, 2022

(30) Foreign Application Priority Data
May 28, 2021 (IN) 202111023892

(51) Int. Cl. G06F 7/556; G06F 7/535; G06F 7/50

(52) U.S. Cl. CPC G06F 7/556; G06F 7/535; G06F 7/50

(57) ABSTRACT

An exponential calculator based on parallel computing is disclosed. The exponential calculator includes a master system and a plurality of nodes interconnected with each other to transfer and receive information and perform sub-computations independently and simultaneously. The master system is configured to select a number of nodes from the plurality of nodes required to perform sub-computations for calculation of an integer exponent. The selected nodes is configured to receive value of a node base and a node exponent from the master system. The selected nodes calculate a first computation value, a second computation value and a third computation value. The master system is further configured to instruct a sub-set of the selected nodes to perform summation of a final sub-computation of the selected nodes and provide an output.

### CROSS REFERENCES TO RELATED APPLICATIONS

This application claims priority to Indian Patent Application Number 202111023892 entitled “EXPONENTIAL CALCULATOR USING PARALLEL PROCESSOR SYSTEMS” and filed on May 28, 2021, for Bhavesh Lakhotia, which is incorporated herein by reference in its entirety for all purposes.

### FIELD OF THE INVENTION

The present invention relates to parallel processor systems, more specifically, methods and apparatus employing parallel processor systems for arithmetic operations.

### BACKGROUND OF INVENTION

ALU (arithmetic and logic unit) is the core of a computer system—it performs arithmetic and logic operations on data that not only realizes the goals of various applications (e.g., scientific and engineering programs), but also manipulates addresses of the data (e.g., pointer arithmetic). The most common arithmetic operations include addition, subtraction, division and multiplication.

In addition to common arithmetic operations, some special arithmetic functions include for example, logarithmic and exponential functions. Logarithmic functions and exponential functions are inverses of each other. The exponential functions are useful in real-world situations. Exponential functions are used to for example, model population, carbon date artifacts, help coroners determine time of death, compute investments, etc.

One of the efficient algorithms present to calculate the integer exponents uses an algorithm known as repeated squaring in modern computers. This algorithm has certain limitations, one of which includes each iteration using the result of the previous iteration to calculate the final result. In other words, the results are calculated in a sequential order as none of the computations are performed in parallel. Each iteration causes the subsequent computation to slow down as the number of digits calculated double on every iteration in general. The arithmetic operation for creating each iteration is multiplication, which is slower than the arithmetic operation of addition and subtraction. As compared to serial computing, parallel computing performs better modelling, simulating and understanding of complex, real-world phenomenon. Thus, parallel computing can save time, memory computer memory and provide concurrency.

None of the available solutions calculate integer exponents in parallel configuration. Therefore, there arises a requirement of efficient and fast exponential calculator.

### SUMMARY

The present invention disclosure provides an electronic/digital exponential calculator based on parallel computing. The digital exponential calculator includes one or more counters, comparators, processors, a master system and a memory. The components act together as a system to calculate integer exponents for any base. The foregoing features and other features as well as the advantages of the invention will become more apparent from the following detailed description, which proceeds with reference to the accompanying figures.

### BRIEF DESCRIPTION OF THE DRAWINGS

The summary above, as well as the following detailed description of illustrative embodiments, is better understood when read in conjunction with the apportioned drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale.

FIG. 1 depicts architecture of the exponential calculator 200 in accordance with an embodiment of the present invention.

FIG. 1a depicts a flow diagram of the master system 101 in accordance with an embodiment of the present invention.

FIG. 2 depicts a flow diagram of the exponential calculator 200 in accordance with another embodiment of the present invention.

### DETAILED DESCRIPTION OF DRAWINGS

Prior to describing the invention in detail, definitions of certain words or phrases used throughout this patent document will be defined: the terms “include” and “comprise”, as well as derivatives thereof, mean inclusion without limitation; the term “or” is inclusive, meaning and/or; the phrases “coupled with” and “associated therewith”, as well as derivatives thereof, may mean to include, be included within, interconnect with, contain, be contained within, connect to or with, couple to or with, be communicable with, cooperate with, interleave, juxtapose, be proximate to, be bound to or with, have a property of, or the like; Definitions of certain words and phrases are provided throughout this patent document, and those of ordinary skill in the art will understand that such definitions apply in many, if not most, instances to prior as well as future uses of such defined words and phrases.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Although the operations of exemplary embodiments of the disclosed method may be described in a particular, sequential order for convenient presentation, it should be understood that the disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed herein. Moreover, for the sake of simplicity, the attached figures may not show the various ways in which the disclosed system, method, and apparatus can be used in combination with other systems, methods, and apparatuses.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and apportioned claims, or may be learned by the practice of embodiments as set forth hereinafter.

According to embodiments of the subject matter disclosed in this application, exponential calculation is performed by a re-designed hardware for binary number operations. The implementation can be carried out in software (e.g., using machine instructions for the existing underlying hardware for binary operations), in hardware (e.g., re-designing the circuitry for operations on binary numbers), or in a combination of software and hardware. As a result, accurate and fast computation is performed. In addition, the system could be implemented inside a calculator, or a system that computes on a global scale over the internet or on the cloud with each computing unit providing input in parallel.

It is to be noted that the following properties are derived to support the calculations for the exponential calculator 200. Let Nₖ be the set of first k natural numbers: Nₖ={1,2,3,4 . . . k}. Let a≠P₁≠P₂≠P₃≠ . . . ≠Pₖ be (k+1) say complex numbers. Define Prod(j) as:

$$Prod ( j ) = {\prod }_{i \neq j}^{k} ( {P}_{i} - {P}_{j} ) \qquad Property 1$$

Then, the following identity holds for natural number n<k:

$${a}^{n} = ( {\sum }_{j = 1}^{k} \frac{{P}_{j}^{n}}{Prod ( j ) * ( a - {P}_{j} )} ) / ( {\sum }_{j = 1}^{k} \frac{1}{Prod ( j ) * ( a - {P}_{j} )} )$$

It is to be noted that the above is an exemplary depiction of the property and there may be multiple variants of the property. Some examples include without limitation:

In one embodiment, multiplying the numerator value and denominator value with a constant does not affect the answer, as is true for all fractions. In other embodiment, the property shifts invariant in Pᵢ's, that is, the following property holds for complex numbers α≠0, and β:

$${a}^{n} = ( {\sum }_{j = 1}^{k} \frac{{( α {P}_{j} + β )}^{n}}{Prod ( j ) * ( a - ( α {P}_{j} + β ) )} ) \text{} / ( {\sum }_{j = 1}^{k} \frac{1}{Prod ( j ) * ( a - ( α {P}_{j} + β ) )} ) \qquad Property 2$$

In other embodiment, the definition of the function prod(j) is represented as follows:

$$Prod ( j ) = {\prod }_{i < j}^{j - 1} ( {P}_{j} - {P}_{i} ) {\prod }_{i > j}^{k} ( {P}_{i} - {P}_{j} ) \qquad Property 3$$

Then, the following variant of the property also follows:

$$= ( {\sum }_{j = 1}^{k} \frac{{( - 1 )}^{k + j} \times {P}_{j}^{n}}{Prod ( j ) * ( a - {P}_{j} )} ) / ( {\sum }_{j = 1}^{k} \frac{{( - 1 )}^{k + j}}{Prod ( j ) * ( a - {P}_{j} )} )$$

In another embodiment, the definition of prod(j) in property 3 is used as:
Setting Pⱼ=J, and
Multiplying numerator value and denominator value by (k−1)!

Then, the following variant of the property also follows:

$${a}^{n} = ( {\sum }_{j = 1}^{k} \frac{{( - 1 )}^{k + j} \times ( \begin{matrix}k - 1 \\ j - 1\end{matrix} ) \times {j}^{n}}{( a - j )} ) / ( {\sum }_{j = 1}^{k} \frac{{( - 1 )}^{k + j} \times ( \begin{matrix}k - 1 \\ j - 1\end{matrix} )}{( a - j )} ) \qquad Property 4$$

In another embodiment, the following definition of prod(j) for j≠k:

Prod(j)=Π_{i≠j}^{k-1}(Pᵢ−Pⱼ), and
Setting a=0, and

n=k−1, and
For J≠K, setting Pⱼ=eⱼ, where eⱼ is an (k−1)th root of unity, and
For j=k, setting Pₖ=x, and
Using the identity:

The following variant is obtained for calculating (k−1)th power of x using only (k−1) nodes:

$${x}^{k - 1} - 1 = {( - 1 )}^{k - 1} / ( {\sum }_{j = 1}^{k - 1} \frac{1}{Prod ( j ) * ( {e}_{j} - x )} ) \qquad Property 5$$

The properties given above are true for all mathematical fields including without limitation finite fields, algebra, calculus and analysis, geometry and topology, combinatorics, logic, number, theory, dynamical systems and differential equations, and mathematical physics, etc. In the present embodiment, the properties given above specifically mention complex numbers. The only restriction is the satisfaction of the following property of the k+1 chosen numbers: a≠P₁≠P₂≠P₃≠ . . . ≠Pₖ. The disclosure applies to the calculation of powers in any mathematical field, subfields or any other abstract mathematical framework, in which the property holds true.

Note also that x\hat{ }(−n)=(1/x)\hat{ }n. Thus, the base can be inverted, and same procedure can be followed with a positive exponent.

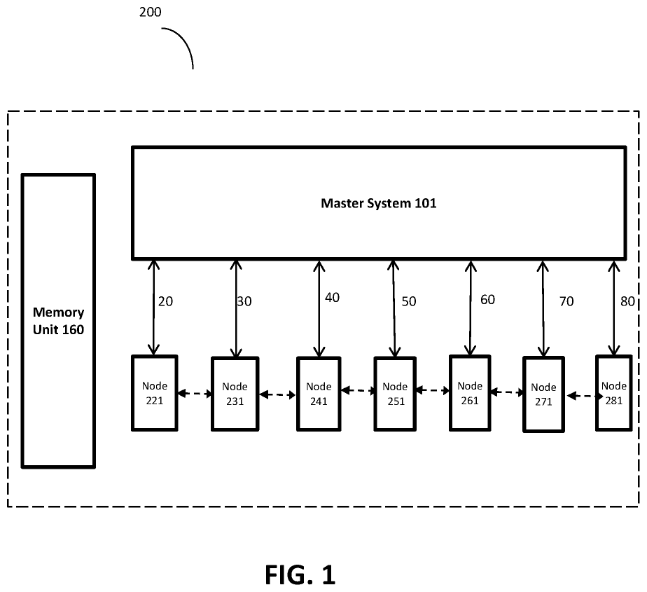

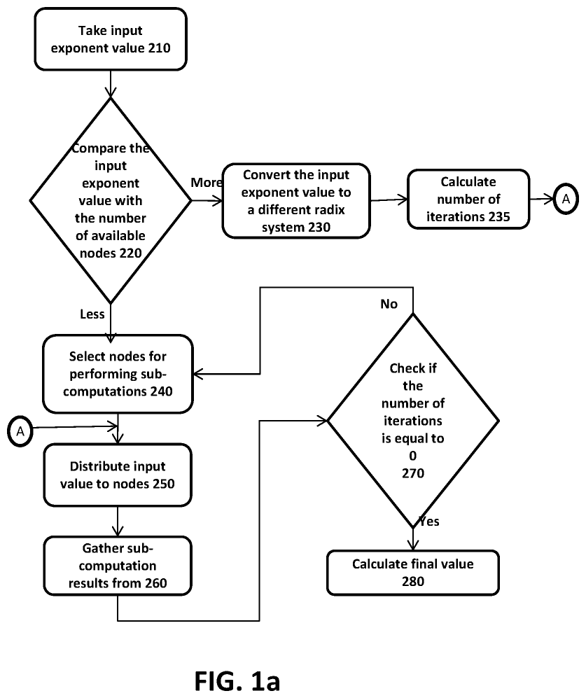

FIG.1 represents an exemplary architecture of an exponential calculator 200. It includes a master system 101 having a memory unit 260 and a plurality of nodes. The number of the plurality of nodes may vary from one to infinite. In the depicted embodiment, seven nodes are shown—nodes 221, 231, 241, 251, 261, 271, 281. The number of the plurality of nodes may vary and more or less number of nodes can be used as per the teachings of the present invention. The master system 101 corresponds with the nodes 221, 231, 241, 251, 261, 271, 281 via respective address buses 20, 30, 40, 50, 60, 70, 80. This exponential calculator 200 may be enclosed as a chipset or a board.

The input to the exponential calculator 200 is an exponential number that includes a base and an exponent. The base can be any complex number. This includes a real number, a fraction or an integer. The exponent can be an integer. The exponent is considered to be of a radix value system (that is, decimal number system). If the exponent is a negative integer, than the output is obtained by reciprocation of the result of the positive exponent. The output may be an integer if the input is an integer with a positive exponent. The output could alternately be a complex number, a fraction, or a real number in case the input is an integer with a negative exponent.

The master system 101 is configured to accept the input (namely, base and exponent value) and compute the output of the exponential calculation. In an embodiment, the master system 101 is a part of a larger processing environment and is allowed to provide the output to a computational query, which forms part of a larger computation. Optionally, the master system 101 may display the output of the exponential calculation.

The master system 101 is connected to every node present in the exponential calculator 200. The data flow between the nodes 221, 231, 241, 251, 261, 271, 281 and the master system 101 takes place via the respective address buses 20, 30, 40, 50, 60, 70, 80. The data flow may be bidirectional irrespective of any data size (e.g., 32-bits, 8-bits, 64-bits, unlimited, etc.). In an embodiment, the master system 101 is accessed without any limitation of a geographical location. The master system 101 may be one or more neural network system, a semantic network system, a processor, a computer, a controller, a digital signal processor, a central processing unit, a state machine, a logic circuitry, and/or any device that manipulates signals based on operational instructions. Among other capabilities, the master system 101 is configured to fetch and execute one or more computer-readable instructions stored in the memory unit 160.

FIG. 1a describes the functioning of the master system 101. At step 210, the master system 101 receives an input exponent value (or exponent). At step 220, master system 101 compares the input exponent value with available nodes in the exponential calculator 200 and determines the optimal number of nodes needed to perform sub-computations. If the input exponent value is less than the number of nodes, it selects the number of nodes present in the exponential calculator 200 as in step 240. The master system 101, for example, selects the desired number of nodes on a random basis for performing sub-computation. Alternately, the master system 101 is aware of the nodes that perform faster sub-computations and accordingly selects such nodes.

However, if the number of nodes in the exponential calculator 200 is less than the input exponent value, the master system 101 converts the input exponent value to a different base or radix system (that is, other than input radix system which is decimal) in step 230. A base or radix is the number of different digits or combination of digits and letters that a system of counting uses to represent numbers. The base or the radix system determined may be a base system corresponding to K−1 nodes. For example, if 8 nodes are present and the exponent value is 579, given the exponent value 579 is greater than number of nodes less one (8−1=7), the master system 101 computes the radix system to be radix 7 system (here K=8, hence 8−1=7).

The master system 101 then converts the decimal exponent value to an exponent value in the determined radix system. In the above example, the value of exponent 579 in decimal system is converted to the radix 7 system as 1455₇(referred as ‘converted radix value’).

Thereafter, the master system 101 determines the number of iterations needed to be performed for exponential calculation as in step 235. For example, the number of iterations (N) may be based on the following formulae:

N=2*d−1−r−s

d=number of digits of the converted exponent value;
r=the number of 1's in the converted radix value;
s=the number of identical digits in the converted radix value −1

Although the present invention is described as using (K−1) nodes to perform maximum exponentiation from K nodes, it is within the scope of the teachings of the present invention that K nodes can exponentiate to a maximum of K.

The above calculation is true for every number system having a different radix. Alternately, similar formulas may be used to obtain the same results/calculations.

The master system 101 is further configured to distribute the node exponent values to the selected nodes, step 250.

The master system 101 receives the sub-computations from the nodes, step 260. Additionally, the master system 101 instructs a sub-set of the selected nodes to perform summation of a final sub-computation of the selected nodes and provide an output. Thereafter, the master system 101 conducts a check if the number of iterations is equal to zero at step 270. If not, it repeats the tasks of steps 240-270 until the number of iterations becomes zero.

The master system 101 is configured to calculate the final value (output), step 280.

The nodes 221, 231, 241, 251, 261, 271 and 281 are configured to perform one or more sub-computations instructed by the master system 101. The nodes 221, 231, 241, 251, 261, 271, 281 are connected in parallel configuration with the master system 101. Further, the nodes are interconnected with each other to transfer and receive information independently and/or simultaneously from one of the master system 101 or other nodes. The nodes 221, 231, 241, 251, 261, 271, 281 may be a dedicated physical unit ora unit coded in a programming language that performs the same operation. Alternately, the nodes 221, 231, 241, 251, 261, 271, 281 may be different computing units in different geographic locations connected over the internet that receive computing instructions from the master system 101. The parallel processing/computing configuration reduces the load of the master system 101, the response time of exponential calculation, processing requirements, etc.

The sub-computations include one or more arithmetic and logic operations. In the present embodiment, the arithmetic operation performed by the nodes 221, 231, 241, 251, 261, 271, 281 includes without limitation, addition, subtraction, multiplication and division.

Each node 221, 231, 241, 251, 261, 271, 281 is tasked to perform one or more sub-computations. The sub-computations include without limitation performing one or more pre-calculations and calculating a second computation value, a third computation value, etc. The pre-calculations include calculating a coefficient, an index value, and a first computation value.

Each node 221, 231, 241, 251, 261, 271, 281 calculates the coefficient as for example, a binomial coefficient on the basis of the above mentioned properties.

In the exemplary embodiment, the disclosure uses property 4 for calculating the coefficient, however, other embodiments may use any of the property variants in an analogous manner to compute the final output.

In one embodiment, the binomial coefficient is calculated using Pascal's triangle. However, other methods of calculating a binomial coefficient can be used as per the teachings of the present invention. In an embodiment, the binomial coefficient is stored in a table in the respective node as pre-calculated values as these are static. In an embodiment, the index value (J) is equivalent to the number of the node at which the sub-computation is performed out of the total nodes present in the exponential calculator 200. The value of J ranges from 1 to infinite depending upon the number of available nodes in the exponential calculator 200.

In one embodiment, the first computation value (FCV) is dependent upon the index value and the co-efficient. For example, the node calculates the FCV by multiplying the coefficient and index value as per the following formulae:

FCV=coefficient*[(−1)^{(J+k)}]

Alternately, the first computation value (FCV) in node J is calculated using the formula based on the above property (4):

$$FCV = Prod ( j ) = \frac{1}{{\prod }_{i \neq j}^{k} ( {P}_{i} - {P}_{j} )}$$

Here, Nₖ is the set of first k natural numbers: Nₖ={1,2,3,4. . . k} and P₁≠P₂≠P₃≠ . . . ≠Pₖ are k complex numbers not equal to the base a.

Similarly using the above identity the second computation is calculated in the node J is as follows:

SCV=Prod(j)*Pⱼⁿ

Here, and P₁≠P₂≠P₃≠ . . . ≠Pₖ are k complex numbers not equal to the base a and n is the node exponent to be calculated.

In one embodiment, the second computation value (SCV) is dependent upon the first computation value, the index value and the number of nodes. For example, the node calculates the SCV by multiplying of the first computation value and as per the following formulae:

SCV=FCV*(J^{k-1})

Here, viewing the node as an independent component, k−1 is termed the node exponent supplied to the node. The node base is analogously defined as the base supplied to the node.

The third computation value (TCV) in node J is calculated using the formulae:

TCV=1/(Pⱼ−a)

Here, a is the base being exponentiated and P₁≠P₂≠P₃≠ . . . ≠Pₖ are k complex numbers not equal to the base a.

In one embodiment, the third computation (TCV) is dependent upon the base and the index value J. For example, the node calculates the TVC by subtracting from the base, the index value J and inverting the obtained value. Thus, the third computation is 1/(J−a) where a is the base.

TCV=1/(J−a)

The nodes 221, 231, 241, 251, 261, 271, 281 are further tasked to perform a summation of two/or more sub-computations, as directed by the master system 101 and transfer the results of the summation to a connected node or to the master system 101.

The nodes 221, 231, 241, 251, 261, 271, 281 are configured to store one or more of the aforesaid values. For example, for a given node, the index value remains same. Hence, the same can be stored in a memory of the respective node which would eliminate the need of re-calculation every time, reduce the processing time and increase the calculation speed. The index value may be stored in the memory of the node or the master system 101 as configured.

The memory unit 160 is configured to be accessed by the nodes and/or the master system 101 through wired or wireless connections. The memory unit 160 may be distributed or united in one place. The memory unit 160 may be, for example, but not limited to, volatile memory, such as static random-access memory (SRAM) and dynamic random-access memory (DRAM), and/or a non-volatile memory, such as read-only memory (ROM), erasable programmable ROM, flash memories, hard disks, optical disks, and magnetic tapes. The memory 160 may include a memory controller or a memory processing unit to process and store the data. The data may be a sub-computation value, an exponential value, or any numerical value. The size of the memory or the memory unit 160 may depend upon the number of nodes used in the sub-computation. The size of the memory may be 16-bits, 32-bits, 64-bits and 128-bits etc.

The address bus 20, 30, 40, 50, 60, 70, 80 is configured to transfer the data between the master system 101 and one or more nodes 221, 231, 241, 251, 261, 271 and 281. The address bus 20, 30, 40, 50, 60, 70, 80 determines the location in memory that the master system 101 will read or write data for processing. The address buses 20, 30, 40, 50, 60, 70, 80 follow communication protocols which may be universal serial bus, RS-232, controller area networks (CAN), eSATA, and others. The address bus 20, 30, 40, 50, 60, 70, 80 size include without limitation 8 bits, 16 bits, 32 bits, 64-bits or unlimited.

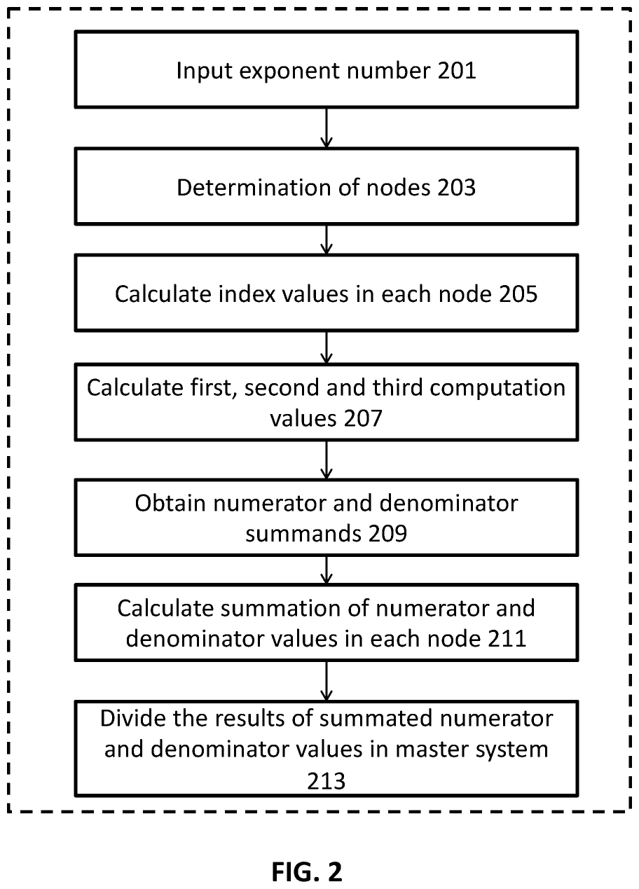

The components of the exponential calculator 200 perform calculation as described in the flowchart of FIG. 2. For the sake of better understanding, each step has been described using a base value of 10 and an exponent value of 579. The number of nodes in the exponential calculator 200 is 8.

At step 201, the process of exponential calculation commences with the master system 101 receiving the inputs from a user. The inputs include a base value and an exponent value.

At step 203, the master system 101 checks the exponent value and determines the number of iterations and corresponding nodes needed to perform the sub-computations. The master system 101 first checks if the exponent value is more than the number of available nodes. Available nodes correspond to nodes that are functional. The master system 101 is configured to keep information of functional versus non-functional nodes. It is possible that all the nodes connected to the master system 101 are functional or a select few nodes are functional. The master system 101 accordingly compares the exponent value with the available nodes. In an optional embodiment, the master system 101 is configured to check the number of available nodes at the start of each iteration.

If the number of nodes are less than the exponent value, the master system 101 converts the decimal exponent value to a radix K−1 value. Thereafter, the master system 101 calculates the number of iterations needed to perform exponential calculation along with number of nodes needed in each iteration. For this, the master system 101 takes into account the number of digits of the converted exponent value, the number of 1's in the converted radix value and the number of identical digits in the converted radix value.

The master system 101 then communicates with the determined number of nodes in respective iteration. The master system 101 transfers the value of base, and exponent for a given iteration to the determined nodes. The value of the base (a) and exponent (n) is transferred to the nodes (k) through the respective address buses 20, 30, 40, 50, 60, 70, 80.

In each iteration, as depicted in step 205, the selected node calculates the co-efficient, the first computation value (FCV) and the second computation value (SCV) using formulae as described above. The said values are stored in the nodes to be fetched from the memory to perform sub-computations as needed and/or to aid the exponentiation of any unknown base.

At step 207, the selected node calculates the third computation value (TCV) depending upon the node base, and the index value J. In an embodiment, the third computation value is calculated using 1/(J−10) for the selected node with J being the number of the node.

At step 209, in the selected node, the second computation value and third computation value are multiplied to obtain the numerator summands. Thereafter, the selected node calculates the denominator summands by multiplying the first computation and third computation value.

Alternately, the sub-computation of step 209 could be further subdivided into two/more nodes, each calculating the first summand (numerator value) and second summand (denominator value) of the value respectively.

At step 211, the selected node calculates the summation of numerator and denominator values using parallel processing/computing as instructed by the master system 101. For example, the master system 101 instructs the node 221 to transfer the sub-computation in node 221 to node 231. The node 231 then sums its own and the transferred sub-computation as instructed. Further, the master system 101 instructs the node 241 to transfer the sub-computation in node 241 to node 251. The node 251 then sums its own and the transferred sub-computation as instructed. The summations of nodes 231 and 251 are then further summated similarly in either node 231 or 251 as instructed by the master system 101. This process can be analogously extended for other nodes 261, 271, 281.

At step 213, the final summated sub-computations of the nodes 221, 231, 241, 251, 261, 271, 281 are transferred to the master system 101. Once the summations of the sub-computations are determined and transferred to the master system 101 by the nodes/selected nodes 221, 231, 241, 251, 261, 271, 281, a final calculation is made by the master system 101 to determine the output. The master system 101 divides the results of summated numerator and denominator value collected from the nodes 221, 231, 241, 251, 261, 271, 281 and displays as the output 280 of the exponential calculator 200.

In cases where two or more iterations of the selected nodes are to be performed, the master system 101 performs the simple multiplication of the values obtained from the nodes in respective iteration.

### EXAMPLE 1: 10⁷

In an exemplary embodiment is used to describe the method of performing exponential calculation, the base value is 10 and the exponent value is 7. The total number of the node of the exponential calculator 200 is 8 as presented above. Since the value of exponent is less than the number of nodes, the master system 101 selects all the 8 nodes to perform sub-computations. For instance, in the depicted embodiment, 6^{th} node calculates the binomial co-efficient (J₆) using Pascal's triangle, where J is 6. J depicts the node number of the total nodes present in the exponential calculator 200.

In next step, the FCV, SCV and TCV is calculated as presented in the following table. The sub-computation 1 and 2 are calculated for numerator and denominator values by multiplying columns DE and BE respectively as presented in table.

| | The calculation of 10\hat{ }7 | | | | | |
|---|---|---|---|---|---|---|
| | B | | a | 10 | | |
| A | Binomial coefficients * | C | D | E | F | G |
| J | [(−1)\hat{ }(J + 8)] | (J\hat{ }7) | Column B * Column C | 1/(J − 10) | Subcomputation(1) | Subcomputation(2) |
| 1 | −1 | 1 | −1 | −0.11111111 | 0.111111111 | 0.111111111 |
| 2 | 7 | 128 | 896 | −0.125 | −112 | −0.875 |
| 3 | −21 | 2187 | −45927 | −0.14285714 | 6561 | 3 |
| 4 | 35 | 16384 | 573440 | −0.16666667 | −95573.33333 | −5.833333333 |
| 5 | −35 | 78125 | −2734375 | −0.2 | 546875 | 7 |
| 6 | 21 | 279936 | 5878656 | −0.25 | −1469664 | −5.25 |
| 7 | −7 | 823543 | −5764801 | −0.33333333 | 1921600.333 | 2.333333333 |
| 8 | 1 | 2097152 | 2097152 | −0.5 | −1048576 | −0.5 |
| | | | | | Numerator | Denominator |
| | | | | Total | −138888.8889 | −0.013888889 |
| | | | | Ans | 10000000 | |

Lastly, the values of column F and G are summated individually and the resultant value is sent to the master system 101. The final computation is performed by the master system 101 before displaying the result.

### EXAMPLE 2: 10⁵⁷⁹

In this exemplary embodiment, exponential calculation is performed with the base value of 10 and the exponent value being 579. The total number of the nodes of the exponential calculator 200 are 8. The master system 101 checks whether the value of exponent is more than the number of available nodes. Since the value of exponent is more than the number of nodes, the master system 101 converts the decimal exponent value to radix 7 system (namely, K−1 radix system). As a result of conversion, the master system 101 calculates the radix 7 value as 1*7\hat{ }3+4*7\hat{ }2+5*7\hat{ }1+5*7\hat{ }0=(1455)₇.

The master system 101 determines the number of iterations required to perform exponential calculation. The master system 101 determines d=4, r=1, s=1 and calculates N=5 using the aforesaid formulae

N=2*d−1−r−s

Thus, the master system 101 determines that five iterations with 8 nodes are to be performed to calculate the output. Given a=10, the master system 101 represents the exponent calculation as follows:

10^{1*7}^{³}^{+4*7}^{²}^{+5*7}^{¹}^{+5*7}^{⁰}=(10⁷*10⁴)⁷* 10⁵)⁷*10⁵

As is evident, the master system 101 distributes the five iterations to available nodes as follows:

Iteration 1 involving 8 nodes=calculation of 10⁷, the sub-computation will be performed as in example 1

Iteration 2 involving 5 nodes=calculation of 10⁴, the sub-computation will be performed as in per the steps provided in FIG. 2

Iteration 3 involving 6 nodes=calculation of 10⁵, the sub-computation will be performed as in per the steps provided in FIG. 2

Iteration 4 involving 8 nodes=calculation of 100000000000⁷, the sub-computation will be performed as in per the steps provided in FIG. 2

Iteration 5 involving 8 nodes=calculation of result of iteration 4 multiplied by 10⁵ to the power 7, the sub-computation will be performed as in per the steps provided in FIG. 2

The master system 101 stores the results obtained after each iteration. For example, values of 10^{7,} 10^{5,} and 10⁴ are calculated in the nodes and thereafter transferred to the master system 101. However, the product of values of two iterations, for example, 10000000*10000 is calculated in the master system 101. Similarly, other iterations 100000000000⁷ and result of iteration 4 multiplied by 10⁵ to the power 7 are calculated in nodes.

Finally, the result is calculated and displayed by the master system 101.

Although the proposed system has been elaborated as above to include all the main modules, it is completely possible that actual implementations may include only a part of the proposed modules or a combination of those or a division of those into sub-modules in various combinations across multiple devices that can be operatively coupled with each other, including in the cloud. Further the modules can be configured in any sequence to achieve objectives elaborated. Also, it can be appreciated that proposed system can be configured in a computing device or across a plurality of computing devices operatively connected with each other, wherein the computing devices can be any of a computer, a laptop, a smartphone, an Internet enabled mobile device and the like. All such modifications and embodiments are completely within the scope of the present disclosure.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

The scope of the invention is only limited by the appended patent claims. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used.

I claim:

1. An exponential calculator based on parallel computing that computes integer exponents for a given input number, comprising:
a plurality of nodes interconnected with each other to transfer and receive information and perform sub-computations independently and simultaneously;
a master system configured to select a number of nodes from the plurality of nodes required to perform sub-computations for calculation of an integer exponent, the master system receives an input value of a base (a), and an exponent (n);
wherein each of the selected nodes is configured to:
receive value of a node base and a node exponent from the master system;
perform pre-calculation including:
calculating a co-efficient;
determining an index value;
calculating a first computation value dependent upon the index value and the co-efficient;
calculate a second computation value dependent upon the first computation value, the index value and the number of selected nodes;
calculate a third computation value dependent upon the node base and the index value J;
determine a numerator value corresponding to a numerator summand; and
determine a denominator value corresponding to the denominator summand
wherein the master system is configured to instruct a sub-set of the selected nodes to perform summation of a final sub-computation of the selected nodes and provide an output.

2. The exponential calculator based on parallel computing of claim 1 wherein, the co-efficient includes a binomial coefficient.

3. The exponential calculator based on parallel computing of claim 1 wherein, the first computation value (FCV) in node J is calculated using the formula:
$$FCV = Prod ( j ) = \frac{1}{{\prod }_{i \neq j}^{k} ( {P}_{i} - {P}_{j} )}$$
wherein, Nₖ is the set of first k natural numbers: Nₖ={1,2,3,4 . . . k}; and
wherein, P₁≠P₂≠P₃≠ . . . ≠Pₖ are k complex numbers not equal to the base a.

4. The exponential calculator based on parallel computing of claim 3 wherein, the second computation value in node J is calculated using the formula:
SCV=Prod(j)* Pⱼⁿ
wherein, n is the node exponent to be calculated.

5. The exponential calculator based on parallel computing of claim 4, wherein the SCV is a stored value in node J, to aid the exponentiation of any unknown base.

6. The exponential calculator based on parallel computing of claim 3 wherein, the third computation value in node J is calculated using the formula:
TCV=1/(Pⱼ−a)
wherein, a is the node base being exponentiated.

7. The exponential calculator based on parallel computing of claim 1 wherein, the master system is configured to check if the exponent is more than the number of available nodes.

8. The exponential calculator based on parallel computing of claim 1 wherein, the master system is configured to determine a number of iterations needed to perform the sub-computations based upon available nodes.

9. The exponential calculator based on parallel computing of claim 8 wherein, the master system is configured to communicate with the available nodes in a respective iteration.

10. The exponential calculator based on parallel computing of claim 1 wherein, the master system is configured to convert the exponent to a radix K−1 value.

11. The exponential calculator based on parallel computing of claim 1 wherein, the master system is configured to check number of available nodes at the start of each iteration.

12. The exponential calculator based on parallel computing of claim 1, wherein the FCV is a stored value in node J, to aid the exponentiation of any unknown base.

13. An exponential calculator based on parallel computing that computes integer exponents for a given input number, comprising:
a master system in communication with a plurality of nodes, the master system configured to receive an input value of a base (a), and an exponent (n), wherein the master system is configured to:
select a number of nodes from the plurality of nodes required to perform sub-computations for calculation of an integer exponent;
transfer value of a node base and a node exponent to the selected nodes;
instruct the selected nodes to perform the sub-computations including pre-calculation, a first computation value, a second computation value, and a third computation value;
receive the sub-computations from the selected nodes; and
instruct a sub-set of the selected nodes to perform summation of a final sub-computation of the selected nodes and provide an output.

14. The exponential calculator based on parallel computing of claim 13 wherein, the master system is configured to determine number of iterations and corresponding nodes needed to perform the sub-computations.

15. The exponential calculator based on parallel computing of claim 13 wherein, the master system is configured to check if the exponent is more than the number of available nodes.

16. The exponential calculator based on parallel computing of claim 13 wherein, the master system is configured to convert the exponent to a radix K−1 value.

17. The exponential calculator based on parallel computing of claim 13 wherein, the master system is configured to communicate with the selected/available number of nodes in respective iteration.

18. An exponential calculator based on parallel computing that computes integer exponents for a given input number, comprising:
a plurality of nodes interconnected with each other to transfer and receive information and perform sub-computations independently and simultaneously, wherein the plurality of nodes are in communication with a master system, wherein upon selection by the master system, each of selected node is configured to:
receive value of a node base and a node exponent from the master system;
perform pre-calculation including:
calculating a co-efficient at the node;
determining an index value;
calculating a first computation value dependent upon the index value and the co-efficient;
calculate a second computation value dependent upon the first computation value (FCV), the index value and number of selected nodes;
calculate a third computation value dependent upon the node base and the index value J;
determine a numerator value corresponding to a numerator summand; and
determine a denominator value corresponding to the denominator summand.

19. The exponential calculator based on parallel computing of claim 18 wherein, the co-efficient includes a binomial coefficient.

20. The exponential calculator based on parallel computing of claim 18 wherein, the first computation value (FCV) in node J is calculated using the formula:
$$FCV = Prod ( j ) = \frac{1}{{\prod }_{i \neq j}^{k} ( {P}_{i} - {P}_{j} )}$$
wherein, Nₖ is the set of first k natural numbers: Nₖ={1,2,3,4 . . . k}; and
wherein, P₁≠P₂≠P₃≠ . . . ≠Pₖ are k complex numbers not equal to the base a.

21. The exponential calculator based on parallel computing of claim 20 wherein, the second computation value in node J is calculated using the formula:
SCV=Prod(j)*Pⱼⁿ
wherein, n is the node exponent to be calculated.

22. The exponential calculator based on parallel computing of claim 21 wherein, the third computation value in node J is calculated using the formula:
TCV=1/(Pⱼ₋a)
wherein, a is the node base being exponentiated.

23. The exponential calculator based on parallel computing of claim 21, wherein the SCV is a stored value in node J, to aid the exponentiation of any unknown base.

24. The exponential calculator based on parallel computing of claim 18, wherein the FCV is a stored value in node J, to aid the exponentiation of any unknown base.
